(19) United States
(12) Patent Application Publication
(10) Pub. No.: US 2003/0139979 A1
(43) Pub. Date: Jul. 24, 2003

(54) Electronic commerce system including customized catalog having encoded information

(76) Inventor: Keith E. Moore, Santa Clara, CA (US)

Correspondence Address: HEWLETT-PACKARD COMPANY, Intellectual Property Administration, P.O. Box 272400, Fort Collins, CO, 80527-2400, US

(21) Appl. No.: 10/051,263

(22) Filed: Jan. 18, 2002

(51) Int. Cl. G06F 17/60

(52) U.S. Cl. 705/27

(57) ABSTRACT

An electronic commerce system and method are disclosed. The system includes a server connected to a network, the server having a processor and storage, the storage including a custom catalog listing items using product identification (PID), the PID identifying both the recipient and the item. The custom catalog can be printed and distributed to potential givers, be available on the server for access via a network, or both. The gift givers can purchase the items via the network, telephonically, or in person.

### BACKGROUND

The present invention relates to an electronic commerce system including customized printed material. In particular, the present invention relates to electronic commerce involving printed catalogs and coordination of the printed catalogs and the electronic commerce system.

A common technique today for bridal and gift registries is to post the registry as web pages accessible on the Internet. Then, potential gift givers (“givers”) are notified of the existence of the registry web pages along with some identifying information to identify the gift recipient (“recipient”) using the web pages. Such technique is inaccessible for those without Internet access. In addition, some givers may be uncomfortable with on-line ordering systems and prefer paper-based catalogs.

Another technique for bridal and gift registries is to distribute a pre-printed catalog from a store to the givers along with identifying information of the recipient. Then, the givers either purchase the listed items at the store or order the items via telephone. Typically, the catalogs are generic catalogs that may include items not needed or wanted by the recipient.

In any case, two divergent interests—one that of mass merchants selling thousands of goods to a large number of consumers using uniform catalogs and two that of a single gift registry entrant wanting a customized item list and personalized catalogs—hinder effective implementation of customized gift registries and catalogs. In some implementations, the catalogs may be tagged (typically on the cover of the catalog) with the registrant's code, but not customized at the item level.

Accordingly, there is a need for an improved system for commerce overcoming these shortcomings.

### SUMMARY

These needs are met by the present invention. According to one aspect of the present invention, a system for electronic commerce is disclosed. The system includes a server connected to a network. The server has a processor and storage. The storage includes a custom catalog listing products using product identification (PID). The PID encodes recipient information.

According to another aspect of the present invention, a method for electronics commerce is disclosed. The method is implemented on a networked computing system and includes the following steps: to select products for inclusion in a custom catalog; to assign a unique product identification (PID) to each of the selected products, the PID identifying the product and a registry associated with a recipient for whom the product is to be purchased; to produce a custom catalog listing the selected products and their PID's; to distribute the custom catalog; and to provide means for a gift giver to purchase the products for the recipient.

According to yet another aspect of the present invention, an article of manufacture for a computer includes computer storage storing a program to cause the computer, when executed, to assign a product identification (PID) to an item for sale, the PID also identifying a recipient for whom the item is to be purchased, to produce a custom catalog listing the item having the PID; to distribute the custom catalog; and to provide means for a gift giver to purchase the item for the recipient.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates one environment in which the present invention is implemented;

FIG. 2 illustrates a server according to one implementation of the present invention; and

FIGS. 3A and 3B illustrate a flowchart describing the operations of the present invention.

### DETAILED DESCRIPTION

As shown in the drawings for purposes of illustration, the present invention is embodied in a method of and system for electronic commerce implemented using a server connected to a network. The server includes a processor and storage to implement the server and the storage implementing a registry, the registry comprising database structures and instructions for the processor to administer the registry including instructions to allow a plurality of participants controlled access to the database and to each other.

The present invention is described with reference to numerous details set forth below, and the accompanying drawings illustrating the invention. The following description and the drawings are illustrative of the invention and are not to be construed as limiting the invention. Specific details are described to provide a thorough understanding of the present invention. However, in certain instances, well-known or conventional details are not described in order to avoid obscuring the present invention in unnecessary detail.

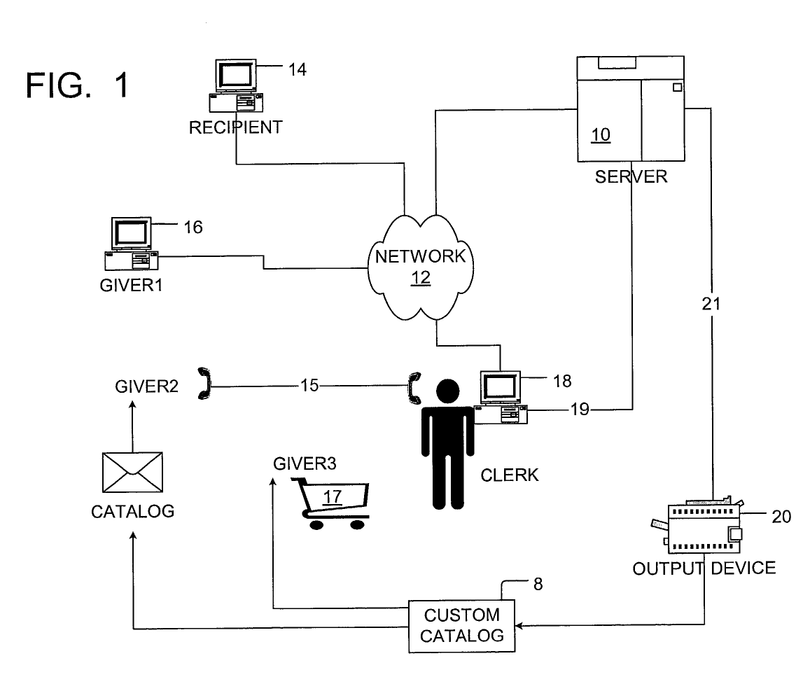

FIG. 1 illustrates one environment in which the present invention is implemented. A server computer 10 is connected to a network 12 connecting one or more client computers such as a recipient client 14 (or “recipient”), a giver client 16 (or “giver”), store clerk client 18 (or “store” or “clerk”), or any combination of these. The server 10 is also connected to other devices such as an output device 20. The server 10 can be directly connected to some of these clients or devices without having to rely on the network 12 for the connection. These direct connections are illustrated using lines 19 and 21. In one embodiment, the network 12 is the Internet.

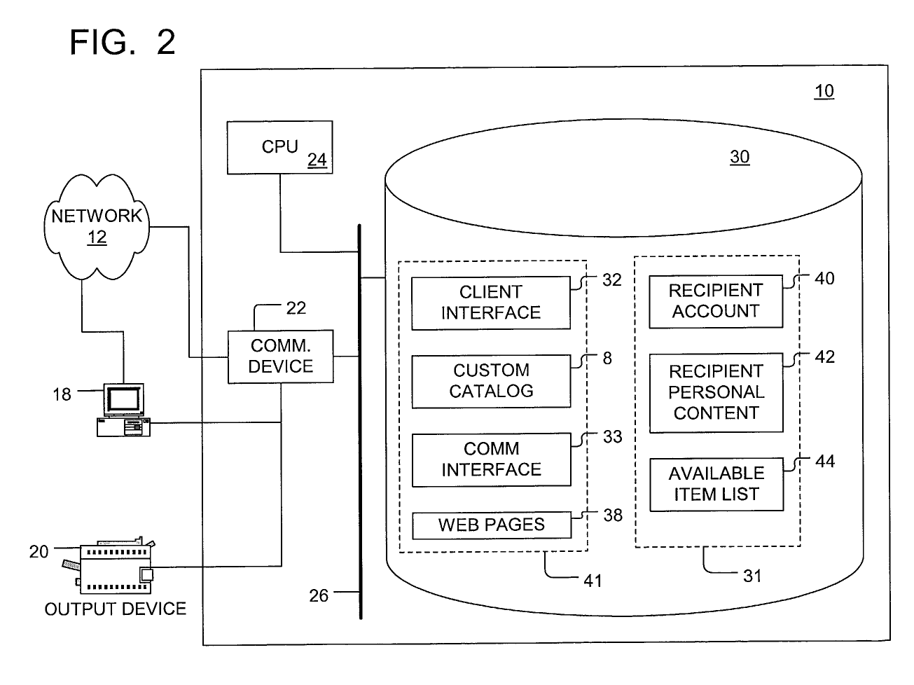

FIG. 2 illustrates the server 10 in more detail. The server 10 includes a communications device 22 through which the server communicates with the network 12, the clerk 18, and the output device 20. The server 10 also includes processor 24 and storage 30. The communications device 22, the processor 24, and the storage 26 are connected to each other via a system bus 26. The server 10 implements a registry having database structures 31, or database, and instruction 41 for the processor 24 to administer the registry including instructions 41 to allow a plurality of participants controlled access to the database 31 and to each other. Here, participants are defined as anyone accessing the registry including, but not limited to, the recipient 14, the giver 16, and the store (as represented by the clerk 18). Moreover, participants may include other casual users accessing the registry. The database 31 and the instructions 41 of the registry are discussed herein below in more detail and in combination with the Figures.

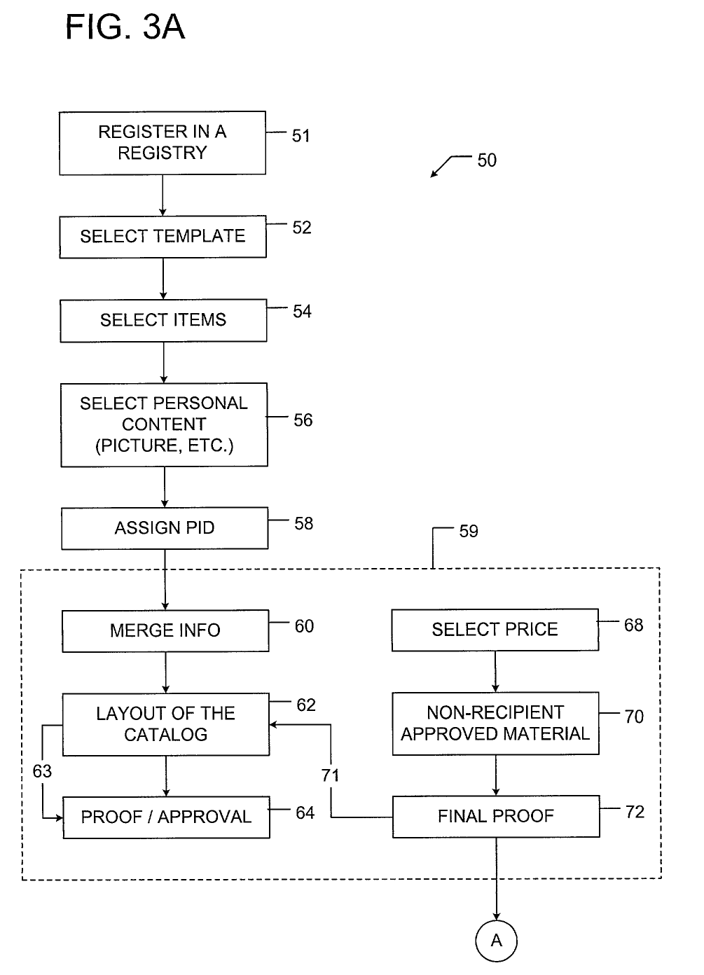

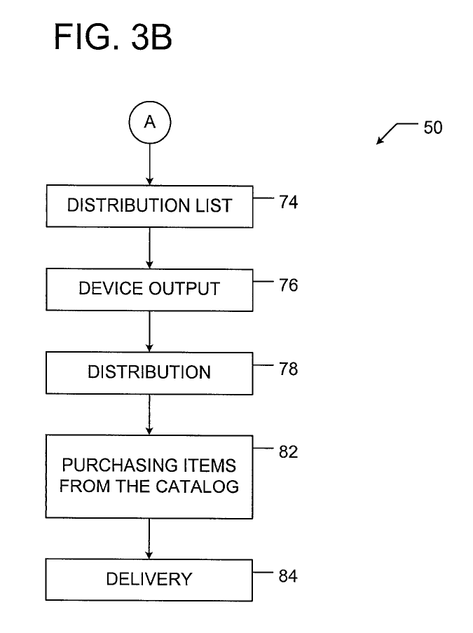

The methods of the present invention as implemented using instructions 41 of the registry are illustrated in flowchart 50 of FIGS. 3A and 3B. In FIGS. 2, 3A and 3B, first, a gift recipient registers with a gift registry of a registry service provider, for example, a retail store. Step 51. For example, the recipient may register for a wedding gift registry and is given some identifying information such as a registry number by the store. The recipient can visit the store for the registration; however, in one embodiment, the recipient uses a client computer 14 to access the server 10 to register for a registry. Here, the registrant is the recipient.

Next, a catalog template is selected from a number of templates, or layouts, offered by the store. Step 52. The selection can be performed by the recipient, by the store, or both. In addition, the items to be included in the catalog are selected, again by the recipient. Step 54. For example, the recipient can select inclusion of dishes and kitchen utensils but not bedroom furniture that the recipient does not need. Again, the catalog selection and the item selections can be done in person; however, for the present invention, the server 10 includes facilities and means to allow the recipient client 14 to perform the selections over the network 12.

For example, the server 10 includes web pages 38 or other interface programs 32 stored in its storage 30 such that, when executed by the processor 24, provides means for the recipient 14 to perform these functions. These functions include instructions for the processor 24 allowing the recipient 14 to select a catalog template, to select products for inclusion into the custom catalog 8, and to merge persona content into the custom catalog 8. For example, for selecting the catalog template, web pages including an array of sample catalog templates are presented to the recipient 14, and the server 10 accepts a selection from the recipient 14.

Then, the recipient's personal content is selected for inclusion within the custom catalog 8. Step 56. Such content may include the recipient's pictures, description of his or her wedding plans, and the like. Again, the selection of personal content, including uploading of photographs and descriptive text can be performed over the network 12 via facilities provided by the server 10 such as web pages 38 over the Internet 14.

For each item selected by the recipient, a product identification, PID, is generated and assigned. Step 58. In one embodiment, the PID is a single alphanumeric code sequence uniquely identifying both the recipient (perhaps using the gift registry number) and the item. For example, a particular PID, PID₁, may identify the recipient and a specific kitchen flatware set that the recipient has selected in step 52. A unique PID is generated for each of the items selected in step 52 for inclusion into the custom category. The PID can be as simple as a concatenation of the registry number and the item name or number such as the item's SKU (stock keeping unit). Alternatively, the PID can be generated using complex encoding schemes. The PID can be printed on the custom catalog as legible numbers. In addition, the PID can be printed as a barcode, a watermark, or other machine-readable format. For example, barcodes are generally readable using a barcode reader whereas watermarks are considered to be readable by any image capture device such as a digital camera.

Then, the custom catalog is produced. Step 59. The step 59 is includes other steps discussed in more detail herein below as steps 60 through 72. The selected catalog template, selected items, and selected personal content are merged to generate the custom catalog 8. Step 60. The merged information, including the PID's, are laid out as the custom catalog 8. Step 62. The steps 62 and 64 can be repeated until an acceptable layout is attained. Loop 63. The information is merged to customize the items to the recipient. For example, the custom catalog 8 may include pictures of the happy couple (the recipients), pictures of their house, the color scheme of the house, recent pictures of their family, and the couple using/enjoying the equipment (say for a barbeque). The custom catalog 8 may contain only items matching the recipient's body size for example. The recipients can model the actual items for photographs that can be included in the custom catalog 8.

Prices for each of the selected items can be determined here. Step 68. Alternatively, the prices could have been set by the store before the items are even selected in step 54. Alternatively, specials based on mailing date or reprint dates are also included in the pricing model (i.e., using stock, or regular, price and then inserting a special pricing such as an “act-now” coupon).

Next, non-recipient-approved materials are added to the custom catalog 8 within the database 31. Step 70. These include, for example, advertising and promotions for the store, for manufacturer of selected items, or both. Then, the custom catalog 8 is proofed for final layout approval. Step 72. This may involve the recipient, the store, or both. The steps 62 through 72 can be repeated until a desired final layout is achieved. Loop 71. The flowchart 50 of FIG. 3A is connected to the flowchart 50 of FIG. 3B via connector A.

The final layout is stored in the server 10 and is merged with a distribution list, step 74, to be printed out as printed catalog. Step 76. The printed custom catalog 8 includes pictures and descriptions of the selected items, of the recipients, and other information. The listed items are identifiable using the corresponding PID that can be printed in alphanumeric or machine-readable code such as bar code or digital water marking. A printer 20 can be used to produce the printed custom catalog 8.

The custom catalog 8 is also available on-line via the server 10 connected to the network 12 to any participant connected to the network 12 as, for example, web pages. Here, the latest version of the catalog is available as well as a difference catalog (listing things new since this person received the catalog). This online version might be correlated to a giver's code (for example, the giver's address or serial number from the printed catalog the giver is using). In addition, items such as the post wedding events, photos, and pictures of family can be posted to the web and included in a post-event catalog. For example, after the event another mailing can be sent to those people who haven't yet used the registry pointing out other items and allowing these people to also order copies of favorite pictures such as framed pictures of the couple.

The online version of the latest custom catalog, the difference catalog, or any combination of these can be printed, either by the participant or by the store, on demand. In fact, when generated and printed on demand, the PID's generated for the items in the custom catalog can include information identifying the person requesting the custom catalog as well as information identifying or about the item, the registry, the recipient, any participant to the registry, or any combination of these. Such information can include, for example, names, addresses, or identification of the participant record in the database.

The server 10 of FIG. 1 includes means (such as query web pages, to allow the giver to request a printed copy of the catalog including updated catalog, a difference catalog, or the post-event catalog. The updated may not list items already purchased, or include these items but identify them as being already purchased.

The printed catalog is distributed via mail, electronic mail, or other means. Step 78. Then, gift givers may order or purchase items for the recipient using various means such as via the network 12, telephone call 15, or in person 17 at the store. Step 82. When the giver makes purchases telephonically 15 or in person 17, the store clerk assists the purchase by using a clerk client computer 18 connected either to the network 12 or directly to the server 10.

In FIGS. 2, 3A, and 3B, if the ordering is performed via the network 12, the server 10 includes facilities (such as web pages) for the client, a giver, to suggest new items, not included in the catalog, for inclusion in the catalog. This can be implemented using various known methods such as electronic mail or web pages. Further, the server 10 may include facilities for bulletin boards, chat rooms, and other communication methods for the recipient and the givers to use. Chat rooms and such communication facilities are known in the art. Such communications can be directed to the recipient, the store, or both. Each of these techniques, individually, is known in the art. These facilities are also stored in the storage 30 as communication interface instructions 33.

Finally, delivery of the purchased items is made. Step 84. There can be several methods in which the givers may purchase the items listed on the custom catalog 8. For example, Giver1 16 may connect to the server 10 via the network 12 and view the custom catalog 8 presented by the server 10 to the Giver1 16 computer before purchasing one or more items. Giver1 16 uses the PID of the items listed in the custom catalog 8 by typing in the number or scanning the digital water marking or the bar code to select the item to be purchased. Further, the giver may purchase only a portion of an item, thus becoming a part of a group of givers purchasing the same item. In this manner, givers can easily give part of a gift—a difficult process for traditional registry mechanisms.

Another aspect of the ordering step 82 can be means for accepting suggestions for products for inclusion into the custom catalog 8.

In FIG. 2, the storage 30 includes instructions 32 for the processor 24 to provide facilities for the clients 14, 16, and 18 of FIGS. 1 and 2 with the server 10. If the network 12 is the Internet, then the interface instructions 32 can be implemented using web pages 38 using HTML (hyper-text markup language).

Also included in the storage is the recipient's account 40. When a giver, for example giver1 16 of FIG. 1, purchase an item from the custom catalog 8, the purchase price is credited to the recipient for that item in the recipient's account 40. After the close of the registry, the recipient can take delivery of the purchased item (first item) or use the credited amount for purchase of another item (second item). This technique is useful, for example, when the same item has been purchased by more than one giver or insufficient funds have been given to purchase a particular item.

The custom catalog 8 is generated by merging the personal content 42, the selected catalog layout, and selected items from an available items list 44 in the storage 30.

From the foregoing, it will be appreciated that the present invention is novel and offers advantages over the current art. Although a specific embodiment of the invention is described and illustrated above, the invention is not to be limited to the specific forms or arrangements of parts so described and illustrated. The invention is limited by the claims that follow.

What is claims is:

1. A system for electronic commerce, the system comprising a server, connected to a network, the server having a processor and storage, the storage including a custom catalog listing products using product identification (PID), the PID having recipient information encoded therewith.

2. The system recited in claim 1 wherein the server implementing a registry, the registry comprising database structures and instructions for the processor to administer the registry including instructions to allow a plurality of participants controlled access to the database and to each other.

3. The system recited in claim 2 wherein the product identification (PID) further identifies a registry.

4. The system recited in claim 3 wherein the server further comprises:
means for selecting a catalog template;
means for selecting products for inclusion into the catalog; and
means for merging personal content into the catalog.

5. The system recited in claim 4 wherein the means for selecting the catalog template comprises web pages designed to present an array of catalog templates to the recipient and to accept the selection from the recipient.

6. The system recited in claim 4 wherein at least one product of the selected products is associated with regular pricing and special pricing.

7. The system recited in claim 3 wherein the PID is a single code sequence.

8. The system recited in claim 3 further comprises means for presenting the custom catalog to a participant computer, connected to the network.

9. The system recited in claim 8 wherein the custom catalog is a difference catalog.

10. The system recited in claim 8 further comprising means for accepting suggestions for products for inclusion into the custom catalog.

11. The system recited in claim 2 wherein the instructions comprise instructions implementing communications between the participants including a recipient and a giver such as a chat room.

12. The system recited in claim 2 wherein the network is the Internet.

13. The system recited in claim 2 wherein the PID includes information on the participants.

14. The system recited in claim 2 further comprising means for printing the custom catalog listing products using the PID.

15. An electronics commerce method implemented on a networked computing system, the method comprising:
selecting products for inclusion in a custom catalog;
assigning a unique product identification (PID) to each of the selected products, the PID identifying the product and a registry associated with a recipient for whom the product is to be purchased;
producing a custom catalog listing the selected products and their PID's;
distributing the custom catalog; and
providing means for a gift giver to purchase the products for the recipient.

16. The method recited in claim 15 wherein the custom catalog comprises custom content including recipient specific information.

17. The method recited in claim 15 further comprising a step of maintaining a registry account for the recipient for tracking gift credits.

18. The method recited in claim 17 further comprising a step of reallocating purchase price credits for exchanging a first purchased product for a second purchased product.

19. The method recited in claim 15 further comprising a step of accepting a partial purchase of an item.

20. The method recited in claim 15 wherein the means for the purchase includes web page access to the registry via the Internet.

21. The method recited in claim 15 further comprising providing a communication facility for participants, the communication facility including a chat-room.

22. An article of manufacture for a computer, the article comprising:
computer storage;
a program stored in the computer storage, the program, when executed, causing the computer to:
assign a product identification (PID) to an item for sale, the PID also identifying a recipient for whom the item is to be purchased;
produce a custom catalog listing the item having the PID;
distribute the custom catalog; and
provide means for a gift giver to purchase the item for the recipient.
